(19) United States
(12) Patent Application Publication
(10) Pub. No.: US 2025/0067858 A1
(43) Pub. Date: Feb. 27, 2025

(54) METHOD FOR AUTOMATED GAS DETECTION

(71) Applicant: Schlumberger Technology Corporation, Sugar Land, TX (US)

(72) Inventors: Christopher Boucher, Cambridge, MA (US); Lukasz Zielinski, Arlington, MA (US); Manasi Doshi, Cambridge, MA (US); Andrew J. Speck, Milton, MA (US)

(21) Appl. No.: 18/812,715

(22) Filed: Aug. 22, 2024

Related U.S. Application Data
(60) Provisional application No. 63/578,690, filed on Aug. 25, 2023.

(51) Int. Cl. G01S 7/497; G01N 21/39; G01S 17/42; G01S 17/89; G01S 17/95

(52) U.S. Cl. CPC G01S 7/4972; G01N 21/39; G01S 17/42; G01S 17/89; G01S 17/95; G01N 2021/399

(57) ABSTRACT

Systems and methods are described for calibrating an imaging or LIDAR based gas monitoring system for efficiently scanning for gas plumes. In an example, a calibration workflow that improves the accuracy of transformations from observed points in a particular camera frame to a coordinate system that is fixed with respect to the ground, such as a set of latitude, longitude, and height values; or a spherical polar coordinate system centered at the camera where the zenith is perpendicular to the ground.

### BACKGROUND

Calculating the emission rate of fugitive gases is an important part of detecting and determining the extent of leaks resulting from mining activity. These fugitive gas emissions contribute to greenhouse gas emissions that are harmful to the environment. Many fugitive emissions are the result of loss of well integrity through poorly sealed well casings due to geochemically unstable cement. This allows gas to escape through the well itself (known as surface casing vent flow) or via lateral migration along adjacent geological formations (known as gas migration).

Gas imagers scan a finite field of view (“FOV”) at a time. Some solutions include scanning patterns continuously and cyclically iterating through these predefined frames, acquiring images, and marking the images as positive if it sees an identifiable plume within the frame, or negative if it does not. Each acquisition acts as a standalone observation. In solutions with recentering and zooming capabilities, upon plume detection, the imager may recenter on an estimated plume origin and acquire an additional frame at a predefined zoom (same as or different from the original zoom level). Even with optimally selected frames, such a scan cycle is prone to false positives from noise as well as large plumes spread across multiple frames, restricts attribution to sources within these predetermined frames, increases the likelihood of attributing an emission to an incorrect source, reduces the accuracy with which the duration of a leak can be calculated, limits leak rate quantification accuracy, and is susceptible to false negatives if the imager sees a portion of the plume but does not see an identifiable plume origin.

With rising concerns around gas emissions (especially greenhouse gases such as methane and carbon dioxide), it is crucial to accurately detect gas emissions along with their source, duration, and emission rate. As a result, a need exists for a gas imaging system that can adapt to real-time detections and changes.

### SUMMARY

Examples described herein include systems and methods for calibrating an imaging or light detection and ranging (“LiDAR”) based gas monitoring system for efficiently scanning for gas plumes. In an example, a calibration workflow that improves the accuracy of transformations from observed points in a particular camera frame to a coordinate system that is fixed with respect to the ground, such as a set of latitude, longitude, and height values; or a spherical polar coordinate system centered at the camera where the zenith is perpendicular to the ground. Here a frame of the Methane LiDAR camera is the set of range, light intensity, and methane concentration measurements within a conical field of view that are taken while the camera is maintained in a particular orientation for some uninterrupted duration of time.

In an example, methods for the quantification and correction of systematic biases that would otherwise distort the contents of different camera frames during transformation to a common, ground-fixed coordinate system to merge their contents.

Both the foregoing general description and the following detailed description are exemplary and explanatory only and are not restrictive of the examples, as claimed.

### BRIEF DESCRIPTION OF THE DRAWINGS

FIG. 1 is an illustration of an imaging or LiDAR based camera, in accordance with various embodiments.

FIG. 2 is an illustration of beam angles in the camera-fixed coordinate system and of the pan and tilt angles in the mast-fixed coordinate system.

FIG. 3 is an illustration of the relationship between the nominal polar beam angle and the corrected polar beam angle for the same observation point.

FIG. 4 is an illustration of origin displacement on the rendering of LiDAR point cloud of a storage tank in two overlapping frames.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for calibrating a camera in an imaging or LiDAR based gas monitoring system. The transformation of a point measurement of LiDAR range within a certain camera frame to a set of latitude, longitude, and height coordinates for the observed point in a 3D point cloud involves a transformation between three different coordinate systems. For each measurement of LiDAR range by the camera, the line-of-sight vector is first transformed from the centerline of the camera-fixed coordinate system to the direction in that coordinate system where an observation is made. When the camera is oriented in a particular direction by the pan-tilt stage, it scans within a conical field of view, up to a maximum cone half-angle that depends on the model of the camera and the zoom setting. The laser beam scans within this viewing cone, measuring the integrated methane concentration, range, and scattered light intensity.

In certain embodiments, the camera may be a LiDAR spectroscopic methane imager (e.g., LiDAR camera). The LiDAR camera accomplishes quick and accurate leak detection, quantification, and localization, and has the capability to visualize methane plumes as they originate and traverse through a facility. Such visualization helps repair crews pin-point leak sources. In certain embodiments, the LiDAR camera is a fully automated, end-to-end system that detects leaks and their locations, quantifies them, provides visual images and leak rate information on a web-based platform, and notifies operators when leaks are detected.

The LiDAR camera includes sensor hardware that combines Tunable Diode Laser Absorption Spectroscopy (TDLAS) with Differential Absorption LiDAR (DiAL) to detect the methane absorption line at ˜1651 nm and uses a Single Photon Avalanche Detector to detect returning photons. The photons emitted by a laser source return to the detector after impinging on a diffusive surface. Any methane present along the laser path will absorb photons with specific wavelengths. Using TDLAS and DiAL, the LiDAR camera continuously sweeps the output wavelength near one of the characteristic wavelengths of methane (i.e., 1651 nm) providing information about methane concentration along the laser path, while LiDAR provides the distance traveled by the laser beam. The sensor combines these measurements to provide total methane gas concentration along the laser path in parts-per-million-meter (ppm-m) units. To account for environmental effects, a full spectrum is acquired at multiple wavelengths and then the wavelength of interest (˜1651 nm) is extracted. The camera is equipped with a pair of Risley prisms that scan a conical field of view by moving the laser within a cone of up to 12 degrees half cone angle (24 degrees field of view) every 10 milliseconds. The camera has a zooming feature which determines the cone angle scanned by the Risley prisms. The camera hardware is mounted on a pan-tilt stage to scan 3D space around it.

After the LiDAR camera is installed, the camera executes a scanning plan that lists the pan and tilt angles corresponding to locations with equipment that have the potential to leak methane and the zoom level best-suited to scan each equipment. A complete scan of all pieces of equipment in a single camera's line of sight may take a few hours depending on site complexity, after which the scan pattern is repeated. Creation of a frame sequence for emissions monitoring can be aided by LiDAR range measurements, reflected light intensity, and an accompanying RGB camera. For larger sites in which many pieces of equipment may block each other's view, two or more cameras may be installed at different locations.

### Imaging or LiDAR Camera Mounting and Operation

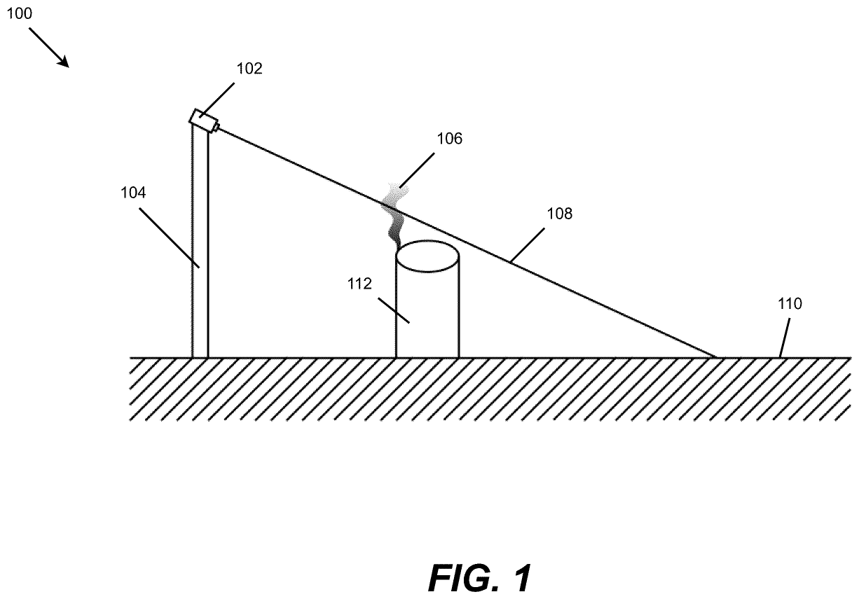

FIG. 1 is an illustration of an exemplary an imaging or LiDAR based camera for a gas monitoring system for performing various methods as described herein. As illustrated in FIG. 1, the system 100 includes a camera 102, mounted on a tall mast 104. Camera 102 is aimed downward as it detects a methane leak 106 so that the laser beam 108 hits the ground 210 and some light can be scattered back to the camera. The camera 102 can be a LiDAR camera. The orientation of the LiDAR camera 102 can be controlled by a pan-tilt stage. The range of pan angles may be up to a full 360 degrees. The range of tilt angles may extend to a maximum of 90 degrees (directly downward) and to a minimum of −90 degrees (directly upward) with the horizon at zero degrees. Because the quantification of methane density requires a return path for scattered radiation, the camera 102 can be mounted on a tall mast 104 so that the infrared laser 108 it emits is scattered by the ground 110 or other surfaces as it scans the equipment 112 at the Oil and Gas facility, as illustrated in FIG. 1. The most frequently used range of tilt angles for emissions monitoring is between zero and 90 degrees.

Given a positive methane leak identification at a point within a frame characterized by a combination of tilt and pan angles, identify the equipment unit or group of equipment that is leaking methane; or alternatively, provide a list of possible leak sources, each with a corresponding attribution confidence level.

Leak attribution requires knowledge of the location of equipment relative to the camera installation. Satellite images, LiDAR scans taken by aircraft, and site blueprints can be used to map out the facility, but these solutions require new scans to be taken or plans updated whenever equipment is added, removed, or relocated at the site. Furthermore, satellite imagery often fails to provide detailed and accurate height measurements of the equipment at the facility.

The most reliable and cost-effective way to maintain an up-to-date three-dimensional model of the site layout is to use the range measurements of the Methane LiDAR camera 102 itself. A continuous panoramic scan may comprise a few hundred distinct camera frames and can be captured in a few hours, after which the camera 102 can resume its methane scan pattern. Capturing a panorama once every month constitutes less than 1% downtime for the camera 102, even less if the panoramic scan frames are also checked for methane leaks. The panoramic scan can also be repeated whenever the camera 102 is taken down for maintenance and then remounted since its orientation may change slightly. If satellite images or aerial LiDAR scans are also available, they can be used to corroborate the 3D model generated from the Methane LiDAR camera measurements. A preponderance of equipment without direct line of sight to the camera suggests either that the camera position is suboptimal, or that the facility is large or intricate enough to merit the installation of two or more cameras at distinct locations.

The transformation of a point measurement of LiDAR range within a certain camera frame to a set of latitude, longitude, and height coordinates for the observed point in a 3D point cloud involves a transformation between three different coordinate systems. For each measurement of LiDAR range by the camera, the line-of-sight vector is first transformed from the centerline of the camera-fixed coordinate system to the direction in that coordinate system where an observation is made.

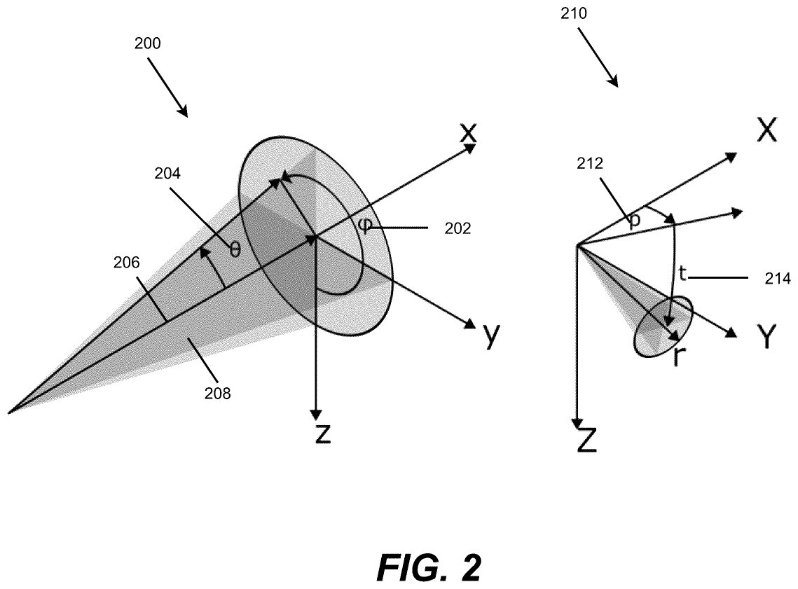

The measurement is first taken in a camera-fixed coordinate system where its position relative to the centerline of the camera's field of view is described by two beam angles. This is illustrated in diagram 200 of FIG. 2. The reported beam angles may be azimuthal angle 202 and polar angle θ 204 in a spherical coordinate system, taking the 206 centerline of the field of view 208 to be the zenith; or they may be projections of the line-of-sight vector onto mutually orthogonal planes that intersect at the centerline 206. Either way, the transformation matrix from the center of the field of view to the line-of-sight vector towards a particular point in that field of view is the product of two rotation matrices, as shown below.

$${r}_{camerafixed} = {M}_{φ} {M}_{θ} [ \begin{matrix}1 \\ 0 \\ 0\end{matrix} ] = [ \begin{matrix}1 & 0 & 0 \\ 0 & cos φ & sin φ \\ 0 & - sin φ & cos φ\end{matrix} ] [ \begin{matrix}cos θ & 0 & - sin θ \\ 0 & 1 & 0 \\ sin θ & 0 & cos θ\end{matrix} ] [ \begin{matrix}1 \\ 0 \\ 0\end{matrix} ]$$

The line-of-sight vector within the camera-fixed coordinate system is next transformed to a mast-fixed coordinate system. This is illustrated in diagram 210 of FIG. 2. This may differ from a ground-fixed coordinate system if the mast is not perfectly upright. The orientation of the camera with respect to the mast is described by the stage pan angle p 212 and tilt angle t 214 that are respectively the azimuthal angle and the complement of the polar angle of a spherical coordinate system, taking the direction downward along the mast as the zenith, as shown below.

$${r}_{mastfixed} = {M}_{p} {M}_{t} {r}_{camerafixed} = [ \begin{matrix}cos p & - sin p & 0 \\ sin p & cos p & 0 \\ 0 & 0 & 1\end{matrix} ] [ \begin{matrix}cos t & 0 & - sin t \\ 0 & 1 & 0 \\ sin t & 0 & cos t\end{matrix} ] {r}_{camerafixed}$$

Finally the line of sight in the mast-fixed coordinate system is subsequently transformed to a ground-fixed coordinate system in which the zenith points directly downward from the camera towards the ground. The ground in the vicinity of the camera's installation at the facility is expected to be flat and level, so that the other two of the three mutually orthogonal axes in the ground-fixed coordinate system extend out towards the horizon. As a further simplifying assumption, the inclination of the mast may be treated as a rigid body rotation by angle n from the zenith, where the rotation axis lies parallel to the ground at an angle m from North, as shown below.

$$= [ \begin{matrix}cos n + {cos}^{2} m ( 1 - cos n ) & cos m sin m ( 1 - cos n ) & sin m sin n \\ cos m sin m ( 1 - cos n ) & cos n + {sin}^{2} m ( 1 - cos n ) & - cos m sin n \\ - sin m sin n & cos m sin n & cos n\end{matrix} ] {r}_{mastfixed} .$$

An alternate formulation would be to treat the mast as a thin cantilever beam where the end touching the ground is fixed. By analyzing camera measurements taken on calm days with lower wind speed, the influence of transient mast sway can be minimized so that the mast incline may be assumed stationary.

The ground-fixed coordinate system provides the Cartesian vector components which represent Easting, Northing, and vertical displacement from the camera; altogether this requires the unit vector representing the zenith in the camera-fixed coordinate system to be multiplied by five rotation matrices. These Cartesian vector components in the ground-fixed coordinate system can be converted to latitude, longitude, and height through the choice of a suitable map projection. The transformed points can be added to a 3D model of the facility, or the heading and pitch of each point may be computed and used to create a panoramic image.

This transformation of LiDAR measurements requires accurate LiDAR range measurements, reliable reporting of the stage pan and tilt angles, and knowledge of the orientation of the mast. In addition, the multiplication of five rotation matrices without intermediate translation terms assumes that all rotations are with respect to a common origin. If the origin used to define the beam angles in the camera-fixed coordinate system does not lie along the pan axis, an additional correction is needed.

To improve the accuracy of the generated three-dimensional (“3D”) point cloud, the calibration methods accounts for systematic biases such as origin displacement of the camera-fixed coordinate system, LiDAR range offset, Pan angle offset, Tilt angle offset, and Mast incline.

### Origin Displacement of the Camera-Fixed Coordinate System.

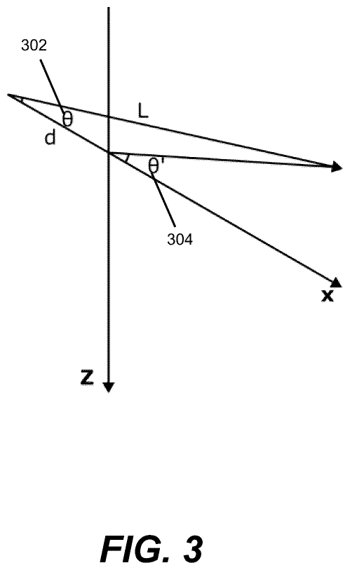

To rotate the centerline of the camera's field of view first to another location in the camera-fixed coordinate system and then to the corresponding direction in the mast-fixed coordinate system assumes that the two sets of rotations share a common origin. In practice this assumption does not hold if the focus of the Methane LiDAR camera is in front of or behind the stage pan axis. This origin displacement can be compensated for by mapping the nominal polar beam angle to the value that the polar beam angle would have if the origins of the coordinate systems coincided. The nominal and corrected polar beam angles are illustrated in FIGS. 3 as θ 302 and θ′ 304.

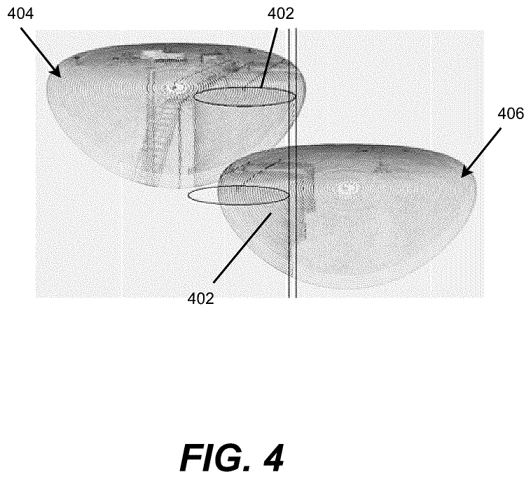

Failure to account for focal plane displacement can cause individual frames to appear overinflated or shrunken depending on whether the focal plane is in front of or behind the pan axis. A panoramic image created by superposing overlapping frames may appear blurry, and point cloud registration algorithms involving incorrectly sized frames become more likely to fail as the number of frames increases. For example, FIG. 4 illustrates two adjacent frames of a group of tanks 402 in a ground-fixed spherical coordinate system. The points in one frame were shifted upward to enable a direct visual comparison. The heading of the right edge of one tank 402 differs by about half a degree depending on whether the tank 402 is on the right side or the left side of the frame, as shown in the uncorrected image 404 on the left. Applying a correction for focal plane displacement can bring the heading coordinate of this tank in the overlapping frames back into agreement, as shown in the corrected image 406 on the right in FIG. 4.

### LiDAR Range Offset

The reported value of the LiDAR range may not indicate the distance from an observed entity to the location where the camera's line of sight intersects the pan axis. One plausible explanation for the reported LiDAR range to show a systematic error would be a fixed optical path length within the camera that is not automatically corrected for.

The static offset to the LiDAR range and the displacement of the origin of the camera-fixed coordinate system are intrinsic properties of the camera and are independent of the mast and the pan-tilt stage. Thus, the range correction and origin displacement would preferably be calibrated for when the cameras are first produced, rather than as part of a lumped calibration step following the mounting of the camera at the facility.

### Pan Angle Offset

The reported pan angle is not necessarily expressed with respect to true North, because the alignment of the camera is performed manually during the installation. The misalignment between the direction of zero pan and the direction of true North is best addressed using a GPS compass during installation. A magnetic compass offers a cheap and convenient alternative, but the mast and surrounding facility may contain enough metal to cause significant magnetic interference in the compass. In addition, the readings of a magnetic compass must be corrected for magnetic declination.

Pan angle offset can be quantified using a target at a fixed distance and direction from the camera. The target is a high-contrast image such as a crosshair pattern that can be detected using the camera's readings of reflected light intensity. The target is mounted at a fixed distance on an arm attached to the camera mast such that the center of the target is along the longitudinal axis of the arm (not offset to one side). The target can be mounted on the same arm as a GPS compass, or the target and compass can be mounted on separate arms with a known, fixed angle between them. After installation, the camera is pointed towards the target and the pan and tilt angles of the target center are recorded. If the compass and target are mounted on the same arm, the pan angle offset is defined as the difference between the pan angle of the target center and the compass heading of the arm. If the compass and target are mounted on separate arms, the pan angle offset is further incremented by the angle between the two arms. It is not necessary to manually aim the camera at the target because images of the target will appear in the results of a panoramic scan if that scan extends to sufficiently high tilt angles.

Alternatively, a high-contrast optical target, a sample of methane at known concentration could be affixed to the arm. The calculation of pan angle offset would be unchanged.

### Tilt Angle Offset

The tilt angle of the pan-tilt stage may show a systematic bias, so that the zenith of the pan-tilt stage may not lie exactly at 90 degrees and the horizon (assuming a vertical mast) may not lie exactly at zero degrees.

Assuming the stage pan axis coincides with the mast center, the tilt offset may be measured using the same target used to measure the pan offset from true North. Given the known length of the target arm and the known distance along the mast from base of the arm to the pan-tilt stage, the tilt angle can be computed using trigonometric relations and compared to the reported stage tilt when the camera views the center of the target. The difference between the measured and computed tilt angles is the tilt angle offset.

### Mast Incline

The mast may not be exactly perpendicular to the ground but could instead be inclined slightly to one side. A simplifying assumption is to treat mast incline as a rigid body rotation about some axis that lies along the ground and intersects the mast at its base, neglecting mast torsion.

The tilt correction and mast incline depend directly on the mechanical performance of the pan-tilt stage, the structural integrity of the mast, and the suitability of the ground where the mast is anchored, so these quantities must be calibrated for after the camera has been installed. If the LiDAR range correction has not already been computed, then it could be computed as part of the same calibration step as the tilt offset and mast incline.

If space permits, optical targets or methane samples on the ground at known locations relative to the mast could be used to independently verify the calibration parameters.

A combination of mast incline and tilt angle offset may result in distortion of the reported ground elevation with both a symmetric and an asymmetric component.

Since the height of the camera above the base in the mast-fixed coordinate system is accurately known, this height can be used to compute values of the tilt correction and mast incline that minimize the discrepancy between the perceived mast height based on LiDAR range values and the true mast height. The tilt correction, mast incline, and the direction in which the mast is leaning can be estimated using an algorithm such as nonlinear least squares regression, where the data points are the LiDAR range and nominal tilt angle for each point where the ground is observed, and the objective is to minimize the root mean square difference between the computed height for each point and the known mast height.

To perform the nonlinear least squares fitting described above, a data set exclusively containing points where the camera is observing flat, level ground is preferred. If the facility is sufficiently sparse that some camera frames from the panoramic scan exclusively contain flat ground with no equipment, these flat frames can be automatically identified by checking that the lowest eigenvalue of a covariance matrix, consisting of the sum of the outer products of the nominal, i.e., uncorrected, position vectors of all points in the mast-fixed coordinate system with themselves, is sufficiently small. If there are too few frames that exclusively contain flat ground with no equipment, then patches of flat ground could be extracted from the frames with any algorithm that can detect planar patches in a 3D point cloud, such as RANSAC. In FIG. 5, a histogram of height measurements of the ground based on LiDAR range measurements from 68 frames is shown. After applying the best-fit values of all calibration parameters, the indicated height values form a much narrower peak centered around zero, which would be consistent with the expectation that the ground at most facilities is flat and level.

The focal plane displacement and LiDAR range offset may be computed prior to camera installation whereas the remaining calibration terms may be computed after the camera is mounted on the pan-tilt stage atop the mast and has taken its first panoramic scan. The calibration routine can be rerun whenever a new panorama is captured, e.g., once per month, to check for degradation in mechanical performance of the mast or pan-tilt stage over time.

For example, the results of the panoramic scan and the accompanying calibration routine can be used to verify individual camera frames taken during routine methane emissions monitoring. The 3D LiDAR point cloud, corrected using all the applicable calibration parameters, can be stored after a panoramic scan is run for the first time. Then, for each frame of the methane emissions monitoring scan pattern, a 3D point cloud can be constructed from that frame and compared against the full 3D point cloud of the panorama using a point cloud registration algorithm, such as iterative closest point (ICP). The output of the point cloud registration algorithm includes the transformation matrix that optimizes the overlap and correspondence between the point clouds. Should the transformation matrix differ substantially from the identity, implying that a large transformation would be needed to bring the point clouds into agreement, then a warning may be issued to the operator or client that the LiDAR camera is returning unexpected results.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for calibrating an imaging or light detection and ranging (“LiDAR”) based gas monitoring system, comprising:
capturing a panoramic scan of an area using a methane LiDAR camera, wherein the panoramic scan comprises a plurality of distinct camera frames;
generating a three-dimensional model of the area based on range measurements obtained during the panoramic scan; and
correcting for focal plane displacement by mapping a nominal polar beam angle in a camera-fixed coordinate system to a corrected polar beam angle that compensates for displacement of the focal plane relative to a stage pan axis;
transforming a line-of-sight vector from the camera-fixed coordinate system to a mast-fixed coordinate system using the corrected polar beam angle; and
determining a pan angle offset by positioning a high-contrast optical target at a fixed distance from the camera, recording pan and tilt angles of the target, and calculating a pan angle offset based on the recorded angles.

2. The method of claim 1, further comprising corroborating the three-dimensional model generated from the methane LiDAR camera measurements with satellite images or aerial LiDAR scans.

3. The method of claim 1, wherein the panoramic scan is repeated at periodic intervals to update the three-dimensional model, and the methane LiDAR camera resumes methane leak detection after the completion of each panoramic scan.

4. The method of claim 1, wherein the static offset in the reported LiDAR range is calibrated independently of the mast and pan-tilt stage during the production of the camera.

5. The method of claim 1, further comprising applying a tilt angle offset correction by comparing the measured tilt angle when the camera views the target to a computed tilt angle based on the known length of the target arm and the distance along a mast.

6. The method of claim 1, further comprising calculating a mast incline by treating the mast as a rigid body rotation about an axis that lies along the ground and intersects the mast at a base of the mast, and using this calculation to correct for discrepancies in reported ground elevation.

7. A system for performing the method of claim 1, wherein the focal plane displacement, LiDAR range offset, pan angle offset, tilt angle offset, and mast incline are recalibrated periodically.

8. A gas monitoring system, comprising:
a methane light detection and ranging (“LiDAR”) camera configured to capture a continuous panoramic scan comprising a plurality of distinct camera frames;
a mast configured to support the methane LiDAR camera, wherein the mast includes a pan-tilt stage for adjusting the orientation of the camera;
a processing unit configured to perform stages comprising:
generating a three-dimensional model of a site layout based on range measurements obtained during the panoramic scan;
correcting for focal plane displacement by mapping a nominal polar beam angle in a camera-fixed coordinate system to a corrected polar beam angle that compensates for displacement of the focal plane relative to the stage pan axis;
transforming the line-of-sight vector from the camera-fixed coordinate system to a mast-fixed coordinate system using the corrected polar beam angle;
compensating for a static offset in the reported LiDAR range caused by a fixed optical path length within the camera; and
determining a pan angle offset by positioning a high-contrast optical target at a fixed distance from the camera, recording the pan and tilt angles of the target, and calculating the pan angle offset based on the recorded angles.

9. The system of claim 8, the stages further comprising corroborating the three-dimensional model generated from the methane LiDAR camera measurements with satellite images or aerial LiDAR scans.

10. The system of claim 8, wherein the panoramic scan is repeated at periodic intervals to update the three-dimensional model, and the methane LiDAR camera resumes methane leak detection after the completion of each panoramic scan.

11. The system of claim 8, wherein the static offset in the reported LiDAR range is calibrated independently of the mast and pan-tilt stage during the production of the camera.

12. The system of claim 8, the stages further comprising applying a tilt angle offset correction by comparing the measured tilt angle when the camera views the target to a computed tilt angle based on the known length of the target arm and the distance along a mast.

13. The system of claim 8, the stages further comprising calculating a mast incline by treating the mast as a rigid body rotation about an axis that lies along the ground and intersects the mast at a base of the mast, and using this calculation to correct for discrepancies in reported ground elevation.

14. The system of claim 8, wherein the focal plane displacement, LiDAR range offset, pan angle offset, tilt angle offset, and mast incline are recalibrated periodically.
